(19) United States
(12) Patent Application Publication
(10) Pub. No.: US 2026/0192453 A1
(43) Pub. Date: Jul. 9, 2026

(54) VEHICLE PRODUCTION MANAGEMENT SYSTEM AND METHOD THEREOF

(71) Applicants: Hyundai Motor Company, Seoul (KR); Kia Corporation, Seoul (KR)

(72) Inventor: Joo Yong Chung, Seocho-gu, Seoul (KR)

(21) Appl. No.: 18/869,462

(22) PCT Filed: Dec. 20, 2022
(86) PCT No.: PCT/KR2022/020789

§ 371 Date: Nov. 26, 2024

(30) Foreign Application Priority Data
Jun. 23, 2022 (KR) 10-2022-0076978

(51) Int. Cl. B25J 9/16; B62D 65/18

(52) U.S. Cl. CPC B25J 9/1669; B25J 9/163; B25J 9/1664; B25J 9/1671; B25J 9/1682; B62D 65/18

(57) ABSTRACT

The present invention relates to a vehicle production management system which includes a function of managing a plurality of robots for delivering a vehicle body and a component in a vehicle production system including a plurality of cells for assembling components, the system including: a work organization part for establishing a movement plan of the vehicle body between cells and an assembly plan in each cell or modifying an established plan; a robot control part for establishing a movement path of the plurality of robots according to the plan established by the work organization part or modifying an established path; and a digital twin verification part for realizing a production scenario in a virtual environment on the basis of the plan established by the work organization part and the movement path established by the robot control part, verifying production efficiency in a realized virtual production scenario and the movement path of the robots, and providing feedback to the work organization part or the robot control part when an abnormality occurs as a result of verification.

### TECHNICAL FIELD

The present disclosure relates to a vehicle production management system and, more particularly, to a vehicle production management system which obtains a route of a robot in a robot route system using the robot that transports a vehicle body or components, such as an autonomous mobile robot (AMR) or an automated guided vehicle (AGV), implements a virtual environment to verify a robot operation through an optimal route, and changes the route of the robot when issues, such as a manufacturing equipment failure, a component quality problem, and work delay, occur.

### BACKGROUND ART

A smart factory, an intelligent manufacturing technology that applies ICT technologies such as recent AI, robotics, IoT, and big data to existing production processes (assembly, logistics, and inspection, etc.) , is a technology that consists of a plurality of cells, and components of a vehicle are assembled in each of the cells.

In the case of an autonomous mobile robot (AMR), which is a robot that t i is able to transport a vehicle body or components, the robot selects one of predefined routes and moves from a starting point to a destination by using its own autonomous driving function. In this case, there are limitations in a scenario for testing the real movement of AMRs and the problem of inability to accommodate the diversity of production plans established on a daily basis.

In a conventional robot route management system, routes of robots are defined in advance, one of the defined routes is selected, and robots move from a starting point to a destination by using the autonomous driving function of the robots. Therefore, setting defined routes is important, and to this end, movement scenarios for various robots are created and checked in advance, and derived optimal routes are loaded into the actual operating system of the robots.

However, there are limitations to testable scenarios prior to movement in the robot route management system. For example, the limited movement scenarios do not accommodate the diversity of production plans established on a daily basis, and this may result in problems with the setting of the predefined routes of robots, such as the overlapping of the movement routes of the robots or the excessive waiting times of the robots during actual movement in the system. It is difficult to resolve these problems in advance as they are identifiable after the movement in the robot route management system.

In addition, the robot route management system operates multiple robots simultaneously, and predefined routes are not defined by comprehensively judging all of the robots, but are optimized routes for each of the robots based on the combination of starting point and destination of the robot. Therefore, when multiple robots are actually operated, problems that have not been verified in advance may occur.

In addition, in order to check whether there were any problems with the movement routes of the robots, the system controlling each of the robots was checked through an emulator that could be tested identically in a virtual environment. However, a conventional emulator has ability to check the operation of a robot by virtually implementing or replacing the actual robot in a system. This checking is performed virtually but in the exact same algorithm as an actual system, and thus execution time is the same as in reality, so there is a time constraint.

For example, to check the route of a robot to support an 8-hour production plan by using an emulator, it takes the same 8 hours as in reality.

In addition, in order to identify problems with the movement routes of AMRs in a smart factory, an emulator capable of testing an AMR control system (ACS), which controls each AMR, identically in a virtual environment is needed. However, the existing emulator performs the testing virtually but in the exact same algorithm as an actual system, and thus there is a time constraint.

Accordingly, a method is emerging to pre-verify the route of a robot in a virtual environment and apply it to an actual system by a virtual reality implementation method that identically transforms physical objects and the real world into a digital world.

The matters described as background art above are only intended to enhance understanding of the background of the present disclosure, and should not be taken as an acknowledgment that the matters correspond to prior art already known to those skilled in the art.

### DISCLOSURE

### Technical Problem

The present disclosure is intended to propose a vehicle production management system which obtains a route of a robot in a robot route system using the robot that transports a vehicle body or components, such as an autonomous mobile robot (AMR) or an automated guided vehicle (AGV), implements a virtual environment to verify a robot operation through an optimal route, and changes the route of the robot when issues, such as a manufacturing equipment failure, a component quality problem, and work delay, occur.

### Technical Solution

As a means for solving the above technical problems, the present disclosure provides a vehicle production management system including a function of managing a plurality of robots that transport a vehicle body and components in a vehicle production system composed of a plurality of cells for assembling the components, the vehicle production management system including: a work organization part configured to establish a movement plan of the vehicle body between the cells and an assembly plan in each of the cells or to modify the established plans; a robot control part configured to establish movement routes of the plurality of robots according to the plans established by the work organization part or to modify the established routes; and a digital twin verification part configured to implement a production scenario in a virtual environment based on the plans established by the work organization part and the movement routes established by the robot control part, to verify production efficiency and the movement routes of the robots in the implemented virtual production scenario, and to feed back an abnormality to the work organization part or the robot control part when the abnormality occurs as a result of the verification.

The vehicle production management system may further include: a production execution part configured to receive the movement plan and the assembly plan established or modified by the work organization part, and to generate a production signal so that a vehicle is produced according to the movement plan and the assembly plan, which are established or modified.

Each of the robots may be a robot that transports the vehicle body or the components.

The work organization part may modify the established plans when an abnormality occurs as the result of the verification of the virtual production scenario implemented by the digital twin verification part.

The robot control part may modify the established movement routes when an abnormality occurs as the result of the verification of the virtual production scenario implemented by the digital twin verification part.

The digital twin verification part may verify the production efficiency and feed back an abnormality to the work organization part when the production efficiency is below preset reference efficiency.

The digital twin verification part may verify the movement routes of the robots and feed back an abnormality to the robot control part when the robots are in a collision or deadlock state.

The digital twin verification part may verify achievement of a planned production quantity when no abnormality occurs as the result of the verification of the production efficiency and the movement routes of the robots.

The digital twin verification part may feed back an abnormality to the work organization part or the robot control part when the abnormality occurs as a result of the verification of the planned production quantity.

The vehicle production management system may further include: a field issue collection part configured to collect a field issue related to equipment, quality, or work occurring in the vehicle production system and to transmit the field issue to the work organization part so as to modify the established plans based on the collected field issue.

The vehicle production management system may further include: a virtual issue generation part configured to generate a virtual issue related to equipment, quality or work capable of occurring in the vehicle production system and to transmit the virtual issue to the work organization part so as to modify the established plans based on the generated virtual issue.

The field issue or the virtual issue may include a manufacturing equipment failure, a quality problem of the components, and work delay.

The work organization part may modify the movement plan of the vehicle body between the cells and the assembly plan in each of the cells, which are established previously, based on the field issue related to equipment, quality, or work occurring in the vehicle production system.

The work organization part may modify the movement plan of the vehicle body between the cells and the assembly plan in each of the cells, which are established previously, based on the virtual issue related to equipment, quality or work capable of occurring in the vehicle production system.

As a method for solving the above technical problems, the present disclosure provides a vehicle production management method including a function of managing a plurality of robots that transport a vehicle body and components in a vehicle production system composed of a plurality of cells for assembling the components, the vehicle production management method including: establishing, by a work organization part, a movement plan of the vehicle body between the cells and an assembly plan in each of the cells or modifying the established plans; establishing, by a robot control part, movement routes of a plurality of robots according to the established plans or modifying the established routes; implementing, by a digital twin verification part, a production scenario in a virtual environment based on the plans established by the work organization part and the movement routes established by the robot control part, and verifying production efficiency and the movement routes of the robots in the implemented virtual production scenario robots; and feeding back, by the digital twin verification part, an abnormality to the work organization part or the robot control part when the abnormality occurs as a result of the verification.

The vehicle production management method may further include: collecting, by a field issue collection part, a field issue related to equipment, quality, or work occurring in the vehicle production system and transmitting the field issue to the work organization part so as to modify the established plans based on the collected field issue.

The vehicle production management method may further include: generating, by a virtual issue generation part, a virtual issue related to equipment, quality or work capable of occurring in the vehicle production system and transmitting the virtual issue to the work organization part so as to modify the established plans based on the generated virtual issue.

### ADVANTAGEOUS EFFECTS

According to the vehicle production management system of the present disclosure, it is possible to obtain a route of a robot in a robot route system using the robot that transports a vehicle body or components, such as an autonomous mobile robot (AMR) or an automated guided vehicle (AGV), to implement a virtual environment to verify a robot operation through an optimal route, and to change the route of the robot when issues, such as a manufacturing equipment failure, a component quality problem, and work delay, occur.

Effects that can be obtained from the present disclosure are not limited to the effects mentioned above, and other effects that are not mentioned will be clearly understood by those skilled in the art to which the present disclosure belongs from the description below.

### DESCRIPTION OF DRAWINGS

FIG. 1 is a block diagram illustrating components of a vehicle production £ management system of the present disclosure.

FIG. 2 is a block diagram illustrating a production scenario implementation environment in a virtual environment of a digital twin verification part.

FIG. 3 is s a flowchart illustrating how the vehicle production management system according to FIG. 1 operates.

FIG. 4 is a flowchart illustrating how the vehicle production management system according to FIG. 1 operates when a field issue occurs or a virtual issue occurs.

### MODE FOR INVENTION

Specific structural or functional descriptions of the embodiments of the present disclosure disclosed in this specification or application are merely illustrated for the purpose of explaining the embodiments according to the present disclosure, and the embodiments according to the present disclosure may be implemented in various forms and should not be construed as limited to the embodiments described in this specification or application.

Since the embodiments according to the present disclosure may be variously changed and may take various forms, specific embodiments are illustrated in the drawings and described in detail in this specification or application. However, this is not intended to limit the embodiments according to the concept of the present disclosure to a specific disclosure form, but should be understood to include all modifications, equivalents or substitutes included in the spirit and technical scope of the present disclosure.

Unless otherwise defined, all terms used herein, including technical or scientific terms, have the same meaning as commonly understood by those skilled in the art to which the present disclosure belongs. Terms defined in commonly used dictionaries should be interpreted as having meanings consistent with their meanings in the context of the relevant technology and are not interpreted in an idealized or overly formal sense unless expressly defined otherwise herein.

Hereinafter, the present disclosure will be described in detail by describing preferred embodiments of the present disclosure with reference to the attached drawings. The same reference numeral presented in each drawing represents the same component.

In the case of the present disclosure, a production plan for the day and movement routes of robots defined in advance are collected, a production scenario is implemented in a virtual environment through a digital twin to pre-verify the operation of the routes of the robots for the same-day production, and solutions are virtually applied and verified within the same system through expected problems discovered through the operation simulation of the robots. In addition, by performing the pre-verification of the system by using the digital twin, difference between the production plan and expected production due to the operation errors of the robots is recognized in advance and utilized for related work.

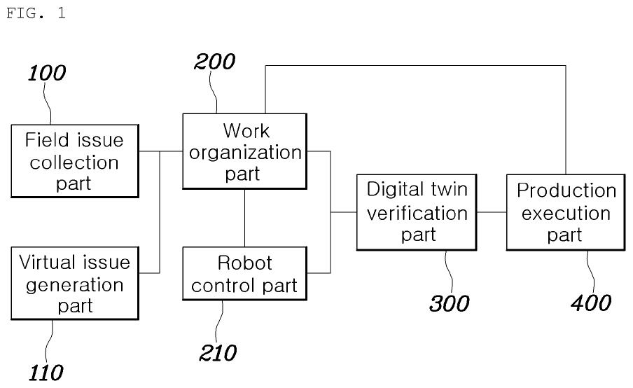

FIG. 1 is a block diagram illustrating components of a vehicle production management system of the present disclosure. FIG. 1 mainly shows components related to this embodiment, and it is obvious that an actual system may include fewer or more components to be implemented.

Referring to FIG. 1, the vehicle production management system according to an embodiment may include a work organization part 200, a robot control part 210, a digital twin verification part 300, a production execution part 400, a field issue collection part 100, and a virtual issue generation part 110.

The vehicle production management system of the present disclosure is composed of a plurality of cells, each of which has the function of assembling components, and is provided with a robot capable of transporting a vehicle body and the components between the plurality of cells.

First, the work organization part 200 is composed of an optimal work organization system and advanced planning and scheduling (APS) and may establish a movement plan of the vehicle body between the cells and an assembly plan in each of the cells or may modify the established plans. Specifically, the optimal work organization system, which constitutes the work organization part 200, may optimally distribute the types of work assigned to workers according to a production situation. For example, when there are 100 tasks required for the assembly of a finished vehicle, tasks 1 to 10 may be assigned to cell 1 according to a current production situation, and tasks 11 to 20 may be assigned to cell 2. In addition, APS, which constitutes the work organization part 200, may establish optimal weekly and daily assembly plans by reflecting customer order situations and production constraint situations. For example, APS may establish weekly and daily assembly plans by calculating the routing (an assembly route) of the day of the finished vehicle, by considering time at which the components are supplied.

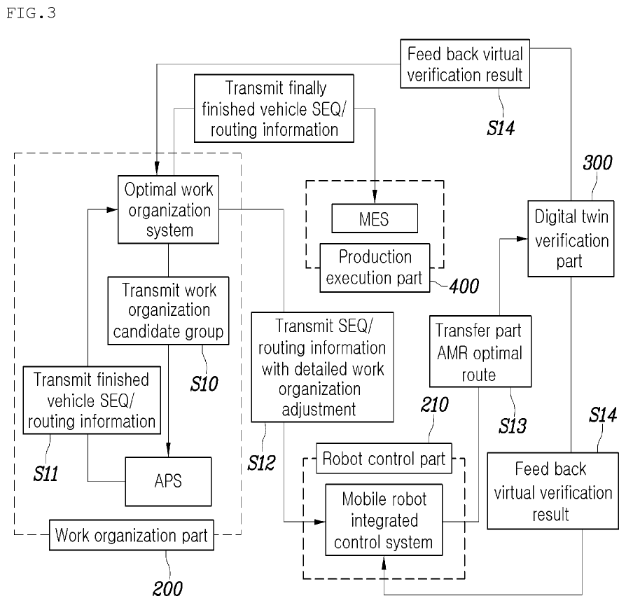

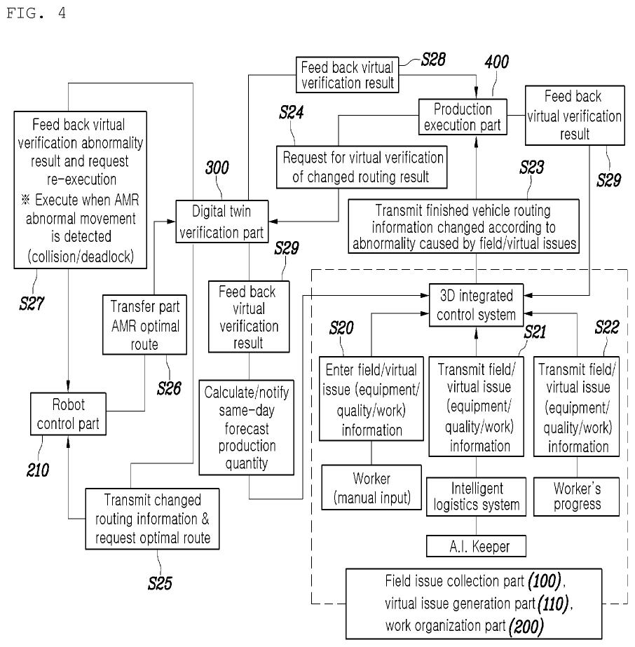

In addition, in the vehicle production management system, the work organization part 200 may modify the established plans when an abnormality occurs as the result of the verification of a virtual production scenario implemented in the digital twin verification part 300. Rerouting, which is the process of reestablishing the assembly route, may be performed in the optimal work organization system constituting the work organization part 200 or a 3D integrated control system, and as illustrated in FIG. 4, the 3D integrated control system may include the field issue collection part 100, the virtual issue generation part 110, and the work organization part 200. Here, when there is no field issue related to equipment, quality, or work occurring in the vehicle production system, or when no virtual issue related to equipment, quality, or work occurring in the vehicle production system are created, rerouting is performed in the optimal work organization system as illustrated in FIG. 3, and when there are a field issue and a virtual issue, rerouting for abnormalities may be performed in the 3D integrated control system. The 3D integrated control system may perform rerouting for an abnormality, which is the function of the work organization part 200, and may monitor various situations occurring in a factory in 3D and issue instructions to perform necessary tasks. For example, when assembly is delayed or equipment breaks down, this situation may be collected in real time and notified to a relevant system.

Next, in the work organization part 200, the robot control part 210 may establish the movement routes of the plurality of robots according to the established plans or modify the established routes. In addition, the robot control part 210 may modify the established movement routes when an abnormality, such as a field issue or a virtual issue, occurs as the result of the verification of the virtual production scenario implemented in the digital twin verification part 300, SO that the robots may immediately respond to the abnormality.

In addition, the robot control part 210 may comprehensively control the movements of the robots, identify the positions of the robots currently transporting the vehicle body and the components, and determine the occurrence of a deadlock when the deadlock occurs between the plurality of robots. When the deadlock is determined to have occurred between the plurality of robots, the deadlock may be resolved by giving priority to the movement of each of the robots according to rules such as predetermined movement routes. Here, the digital twin verification part 300 verifies the movement routes of the robots so that when the robots collide or are in a deadlock, the abnormality may be fed back to the robot control part 210. The deadlock occurrence determination of the robot control part 210 mentioned above may be performed by identifying the positions of the robots currently transporting the vehicle body and the components, but the digital twin verification part 300 may determine whether the robots are in a collision or deadlock state by implementing the production scenario in a virtual environment and verifying the movement routes of the plurality of robots established or modified in the robot control part 210.

Here, each of the robots may be a robot transporting the vehicle body or the components. Here, the robot that transports the vehicle body or components may refer to an autonomous mobile robot (AMR) or an automated guided vehicle (AGV). Specifically, AGV is a robot that is able to send and receive signals through guide lines or additional devices for route guidance, and AMR, which is an automated solution equipped with technologies such as autonomous driving and AI, refers to a robot that is able to form a map of the inside of a work site on its own and make decisions on its own rather than interacting with a separate device when setting routes.

Next, the digital twin verification part 300 may implement the production scenario in the virtual environment based on the plans established by the work organization part 200 and the movement routes established by the robot control part 210, may verify production efficiency and the movement routes of the robots in the implemented virtual production scenario, and may feed back an abnormality to the work organization part 200 or the robot control part 210 when the abnormality occurs as a result of the verification. The implementation of the production scenario in the virtual environment by the digital twin verification part 300 may virtually verify and simulate the vehicle production management system in an actual factory. For example, the movement routes of the plurality of robots may be predicted in the vehicle production management system, and the assembly process of the components in each of the cells may be virtually verified.

In addition, after completing work, the digital twin verification part 300 verifies the production efficiency, and may feed back an abnormality to the work organization part 200 when the production efficiency is below preset reference efficiency. The work organization part 200 establishes the reference efficiency before performing work for the day, and stops the system when the production efficiency after the work is completed is the preset reference efficiency or higher, but feeds back an abnormality to the work organization part 200 when the production efficiency is lower than the reference efficiency so that the reference efficiency is set higher or the assembly plan is modified later.

Accordingly, the digital twin verification part 300 verifies the achievement of a planned production quantity when no abnormality occurs as the result of the verification of the production efficiency and the movement routes of the robots, and may feed back an abnormality to the work organization part 200 or the robot control part 210 when the abnormality occurs as the result of the verification of the planned production quantity. The digital twin verification part 300 may reroute the movement plan of the vehicle body between the cells and the assembly plan in each of the cells in the optimal work organization system or the 3D integrated control system constituting the work organization part 200 when an abnormality occurs as the result of the planned production quantity, and may feed back the abnormality to the robot control part 210 so that the movement routes of the plurality of robots may be modified, thereby verifying the operation of the robots through optimal routes, and changing the routes of the robots when issues, such as a manufacturing equipment failure, a quality problem of the components, and work delay, occur.

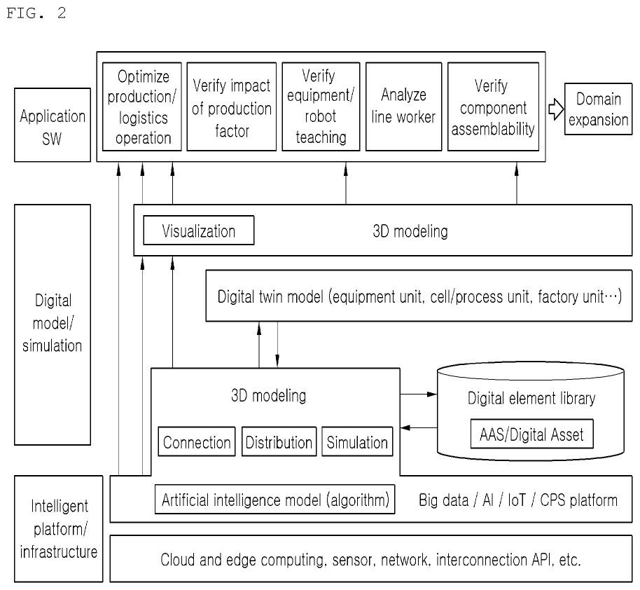

FIG. 2 is a block diagram illustrating a production scenario implementation environment in a virtual environment of the digital twin verification part 300.

As illustrated in FIG. 2, the digital twin verification part 300 may implement the production scenario in the virtual environment based on the production plan of the work organization part 200 and the movement routes of the robot control part 210, verify the movement routes of the robots and the production efficiency in the implemented virtual production scenario, and may feed back an abnormality to the work organization part 200 or the robot control part 210 when the abnormality occurs as the result of the verification. The digital twin is a technology that creates a model of a real vehicle in a virtual space, simulates the model, and then links data obtained through the simulation with the vehicle to simultaneously innovate products and production processes.

More specifically, in the digital twin verification part 300, the implementation of the production scenario in the virtual environment may be performed with a total of three layers. First, there is an area of application software used by a user. The application software may function to optimize production/logistics operations, verify the impact of production factors, verify equipment/robot teaching, analyze line workers, and verify the assemblability of components. A domain may be expanded through the diversity of the areas of the application software used by a user.

Second, there is an area of a digital model and simulation that build virtual environments. A simulator may perform 3D modeling by interacting with a digital element library (AAS/Digital Asset) and a digital twin model. The simulator implements data integration, real-time updating, spatiotemporal alignment matching, and structural analysis techniques. In addition, visualization technology may be implemented through 3D visualization and AR/VR technology, and multidimensional modeling technology may be implemented through multidimensional object extraction, automatic 3D modeling recognition, and 3D model synthesis. Asset management in the digital element library (AAS/Digital Asset) enables asset search operation, asset compression, and asset sharing.

Third, there are various data linkages required for simulation, an intelligent platform in which artificial intelligence algorithms are managed, and an infrastructure area. Specifically, cloud and engine computing, a sensor, a network and interconnection API may be included, and data linkage with IT, virtual object connection, wired and wireless communication, data connection technology through soft sensing, dormant/space/object analysis, correlation/causality analysis, and analysis technology through intelligent systems are required.

Next, the production execution part 400 may receive the movement plan and assembly plan established or modified in the work organization part 200, and may generate a production signal so that a vehicle is produced according to the established or modified movement plan and assembly plan. The production execution part 400 is configured as a manufacturing execution system (MES), and may generate actual line work signals. After obtaining the latest production line information, the production execution part 400 may control the operation of a robot by receiving a final production plan, such as instructing necessary tasks or operating equipment.

In addition, the field issue collection part 100 may collect the field issue related to equipment, quality, or work occurring in the vehicle production system, and may transmit the field issue to the work organization part 200 so as to modify the established plans based on the collected field issue. The field issue collection part 100 may function to collect issues when the issues actually occur in the field. This is intended to collect issues when the issues actually occur in the field and to change optimal route selection when an abnormal situation occurs. Accordingly, real-time information is collected from the field and, when the information is outside a pre-defined range, or when robots are in a collision or deadlock state, an abnormality may be fed back to the robot control part 210.

Likewise, the virtual issue generation part 110 may generate the virtual issue related to equipment, quality or work capable of occurring in the vehicle production system, and may transmit the virtual issue to the work organization part 200 so as to modify the established plans based on the generated virtual issue. It is assumed that an issue is created independently of the occurrence of the field issue, and in this case, a line issue may be created virtually and an abnormality may be fed back to the work organization part 200 so that a robot can operate in an optimal path when an abnormal situation occurs.

Accordingly, the work organization part 200, the work organization part 200 may modify the movement plan of the vehicle body between the cells and the assembly plan in each of the cells which are established previously based on the field issue related to equipment, quality, or work and the virtual issue occurring in the vehicle production system, and accordingly may quickly respond to the field issue and the virtual issue by changing change the route of the robot when issues, such as a manufacturing equipment failure, a component quality problem, and work delay, occur.

Here, the field issue or the virtual issue may include the manufacturing equipment failure, the component quality problem, and the work delay, and may include all kinds of parameters that affect production. For example, when an actual work is delayed compared to a construction method/organization, the production path of each cell is required to be changed, and when there is a collision or deadlock between robots, a robot for a task is required to be changed or the movement routes are required to be recalculated. In addition, when a problem is found with the component quality of a vehicle, the vehicle is required to be removed, repaired, and reinserted, and the production route of each cell is required to be changed. In addition, when an abnormality is found in the equipment of each cell, there may be a case in which the production route of the cell is required to be changed due to the cell being unusable. Accordingly, by implementing a virtual environment of a digital twin before reflecting it on an actual work site, simulation may be conducted by arbitrarily setting parameters. It is obvious to those skilled in the art that the roles of the work organization part 200, the robot control part 210, the digital twin verification part 300, the production execution part 400, the field issue collection part 100, and the virtual issue generation part 110 described so far are not limited to the aforementioned roles and may be shared with each other or performed independently in different systems.

A vehicle production management method according to an embodiment based on the vehicle production management system described above will be described with reference to FIGS. 3 and 4.

FIG. 3 is a flowchart illustrating how the vehicle production management system operates without a field issue and a virtual issue. FIG. 4 is a flowchart illustrating how the vehicle production management system according to FIG. 1 operates when a field issue occurs or a virtual issue occurs.

Referring to FIG. 3, first, the optimal work organization system that constitutes the work organization part 200 may transmit a work organization candidate group to APS at S10. Next, APS may establish the movement plan of the vehicle body between the cells and the assembly plan in each of the cells and may transmit the established plans back to the optimal work organization system at S11. Next, the optimal work organization system may transmit the movement plan of the vehicle body between the cells and the assembly plan in each of the cells to the robot control part 210 at S12, and the robot control part 210 may establish the movement routes of the plurality of robots according to the established plans in the work organization part 200, and may transmit the movement routes to the digital twin verification part 300 at S13. Next, the digital twin verification part 300 may verify production efficiency and movement routes of the robots in a virtual production scenario implemented, based on the plans established by the work organization part 200 and the movement routes established by the robot control part 210, and may feed back the result of the virtual verification to each of the work organization part 200 and the robot control part 210 at S14.

Referring to FIG. 4, FIG. 4 illustrates a case in which a field issue occurs or a virtual issue is created. First, an A. I. keeper is a system that automatically decides whether to proceed by judging the quality results of work performed within each cell. For example, when an assembly quality problem occurs, this may be identified by a vision camera, and a stop signal may be generated to prevent a vehicle from proceeding to the next process. In addition, an intelligent logistics system, which is a system that integrates and manages logistics information within a factory, may calculate the supply order of components required for each time period. A worker progress management system is a system that monitors the work progress of a worker. In a case in which when monitored, the work of the worker is delayed compared to expected work time, a signal that the work is delayed may be transmitted to a relevant system.

Meanwhile, issues, a field issue related to equipment, quality, or work occurring in the vehicle production system or a virtual issue related to equipment, quality, or work occurring in the vehicle production system may be manually input to the 3D integrated control system by a worker at S20, and the 3D integrated control system may receive input the field issue or the virtual issue from an intelligent logistics system or a worker progress management system at S21 and S22.

Next, the 3D integrated control system may transmit the routing information of a finished vehicle modified according to an abnormality caused by the field issue and the virtual issue to the production execution part 400 at S23. Next, the production execution part 400 may request the digital twin verification part 300 to perform a virtual verification of the modified routing result at S24. Next, the digital twin verification part 300 may transmit the modified routing information to the robot control part 210, and may request the work organization part 200 to establish optimal movement routes of the robots according to the established plans at S25.

Next, the robot control part 210 transmits the optimal movement routes of the plurality of robots according to the plans established by the work organization part 200 to the digital twin verification part 300 at S26.

Next, the digital twin verification part 300 may verify the production efficiency and the movement routes of the robots in the virtual production scenario based on the optimal movement routes of the plurality of robots transmitted by the robot control part 210, and may feed back an abnormality to the robot control part 210 when the abnormality occurs as the result of the verification of the movement routes at S27.

Next, the digital twin verification part 300 may feed back the verification result of the production efficiency and the movement routes of the robots in the implemented virtual production scenario to the production execution part 400 at S28.

At the same time, the digital twin verification part 300 may calculate production quantity forecast for the day and notify the calculated quantity while feeding back the virtual verification result to the 3D integrated control system at S29.

Likewise, the production execution part 400 may also feed back virtual verification result to the 3D integrated control system at S29.

In the end, according to the vehicle production management system of the present disclosure, it is possible to obtain a route of a robot in a robot route system using the robot that transports a vehicle body or components, such as an autonomous mobile robot (AMR) or an automated guided vehicle (AGV), to implement a virtual environment to verify a robot operation through an optimal route, and to change the route of the robot when issues, such as a manufacturing equipment failure, a component quality problem, and work delay, occur.

While the present disclosure has been illustrated and described with respect to specific embodiment thereof, it will be apparent to those skilled in the art that the present disclosure may be variously improved and modified without departing from the technical spirit of the present disclosure provided by the claims below.

### DESCRIPTION OF THE REFERENCE NUMERALS IN THE DRAWINGS

100: Field issue collection part
110: Virtual issue generation part
200: Work organization part
210: Robot control part
300: Digital twin verification part
400: Production execution part

1. A vehicle production management system comprising a function of managing a plurality of robots that transport a vehicle body and components in a vehicle production system composed of a plurality of cells for assembling the components, the vehicle production management system comprising:
a work organization part configured to establish a movement plan of the vehicle body between the cells and an assembly plan in each of the cells or to modify the established plans;
a robot control part configured to establish movement routes of the plurality of robots according to the plans established by the work organization part or to modify the established routes; and
a digital twin verification part configured to implement a production scenario in a virtual environment based on the plans established by the work organization part and the movement routes established by the robot control part, to verify production efficiency and the movement routes of the robots in the implemented virtual production scenario, and to feed back an abnormality to the work organization part or the robot control part when the abnormality occurs as a result of the verification.

2. The vehicle production management system of claim 1, further comprising:
a production execution part configured to receive the movement plan and the assembly plan established or modified by the work organization part, and to generate a production signal so that a vehicle is produced according to the movement plan and the assembly plan, which are established or modified.

3. The vehicle production management system of claim 1, wherein each of the robots is a robot that transports the vehicle body or the components.

4. The vehicle production management system of claim 1, wherein the work organization part modifies the established plans when an the abnormality occurs as the result of the verification of the virtual production scenario implemented by the digital twin verification part.

5. The vehicle production management system of claim 1, wherein the robot control part modifies the established movement routes when an the abnormality occurs as the result of the verification of the virtual production scenario implemented by the digital twin verification part.

6. The vehicle production management system of claim 1, wherein the digital twin verification part verifies the production efficiency and feeds back an abnormality to the work organization part when the production efficiency is below preset reference efficiency.

7. The vehicle production management system of claim 1, wherein the digital twin verification part verifies the movement routes of the robots and feeds back an abnormality to the robot control part when the robots are in a collision or deadlock state.

8. The vehicle production management system of claim 1, wherein the digital twin verification part verifies achievement of a planned production quantity when no abnormality occurs as the result of the verification of the production efficiency and the movement routes of the robots.

9. The vehicle production management system of claim 8, wherein the digital twin verification part feeds back an abnormality to the work organization part or the robot control part when the abnormality occurs as a result of the verification of the planned production quantity.

10. The vehicle production management system of claim 1, further comprising:
a field issue collection part configured to collect a field issue related to equipment, quality, or work occurring in the vehicle production system and to transmit the field issue to the work organization part so as to modify the established plans based on the collected field issue.

11. The vehicle production management system of claim 1, further comprising:
a virtual issue generation part configured to generate a virtual issue related to equipment, quality or work capable of occurring in the vehicle production system and to transmit the virtual issue to the work organization part so as to modify the established plans based on the generated virtual issue.

12. The vehicle production management system of claim 10, wherein the field issue includes a manufacturing equipment failure, a quality problem of the components, and work delay.

13. The vehicle production management system of claim 10, wherein the work organization part modifies the movement plan of the vehicle body between the cells and the assembly plan in each of the cells, which are established previously, based on the field issue related to equipment, quality, or work occurring in the vehicle production system.

14. The vehicle production management system of claim 11, wherein the work organization part modifies the movement plan of the vehicle body between the cells and the assembly plan in each of the cells, which are established previously, based on the virtual issue related to equipment, quality or work capable of occurring in the vehicle production system.

15. A vehicle production management method comprising a function of managing a plurality of robots that transport a vehicle body and components in a vehicle production system composed of a plurality of cells for assembling the components, the vehicle production management method comprising:
establishing, by a work organization part, a movement plan of the vehicle body between the cells and an assembly plan in each of the cells or modifying the established plans;
establishing, by a robot control part, movement routes of a plurality of robots according to the established plans or modifying the established routes;
implementing, by a digital twin verification part, a production scenario in a virtual environment based on the plans established by the work organization part and the movement routes established by the robot control part, and verifying production efficiency and the movement routes of the robots in the implemented virtual production scenario robots; and
feeding back, by the digital twin verification part, an abnormality to the work organization part or the robot control part when the abnormality occurs as a result of the verification.

16. The vehicle production management method of claim 15, further comprising:
collecting, by a field issue collection part, a field issue related to equipment, quality, or work occurring in the vehicle production system and transmitting the field issue to the work organization part so as to modify the established plans based on the collected field issue.

17. The vehicle production management method of claim 15, further comprising:
generating, by a virtual issue generation part, a virtual issue related to equipment, quality or work capable of occurring in the vehicle production system and transmitting the virtual issue to the work organization part so as to modify the established plans based on the generated virtual issue.

18. The vehicle production management system of claim 11, wherein the virtual issue includes a manufacturing equipment failure, a quality problem of the components, and work delay.
